(19) United States
(12) Patent Application Publication
(10) Pub. No.: US 2009/0028689 A1
(43) Pub. Date: Jan. 29, 2009

(54) Linear fan

(76) Inventors: Yefim Levin, Boston, MA (US); Vadim Levin, Newton, MA (US)

Correspondence Address: Vadim Levin, 80 Boulder Rd.,, Newton, MA, 02459, US

(21) Appl. No.: 11/818,961

(22) Filed: Apr. 25, 2006

(51) Int. Cl. F03B 9/00

(52) U.S. Cl. 415/5

(57) ABSTRACT

The linear fan comprises blades that are fixed onto a flexible transmission engaging leading and follower pulleys. Each blade has cylindrical shanks to facilitate swivel fixation. The veer of the blades is provided with directive disks. In another embodiment, position of the blades is permanent with respect to direction of motion of the transmissions and connection of the blades with the transmissions is provided with prismatic shanks in such a way that outlines of cross section of the blades are symmetrical with respect to direction of motion of the transmission. This fan also comprises the guide vanes that are fixed in one of two positions, the first position provides forward direction of operation and the second one assures reverse operation of the fan.

### SUMMARY OF THE INVENTION

An object of the invention is to provide large volume of the air with a relatively compact installation of a fan.

This object is accomplished by providing a linear fan comprised of blades fixed on two flexible transmissions. This fixation is swivel. The fan has system of disks and arms that provides changing position of the blades with respect to the belts.

An alternative scheme of the fan is presented wherein the blades do not change their position with respect to the belt, but there are inlet and outlet guide vanes.

The described fan can also be used as a blower.

### BRIEF DESCRIPTION OF THE DRAWINGS.

FIG. 1 is a schematic view of the fan according to the invention.

FIG. 2 illustrates a local section of the fan shown in FIG. 1 and indicated with A in FIG. 1.

FIG. 3 is a partial schematic section of driving unit of the fan shown in FIG. 1 and indicated with B.

FIG. 4 is a lateral section of the unit shown in FIG. 3 and indicated with C.

FIG. 5 is a schematic view of fan different from the one illustrated in FIG. 1 in that the position of the blades is permanent with respect to the belts.

FIG. 6 is an enlarged portion of the view shown in FIG. 5 indicated with G.

FIG. 7 illustrates a local section of the view show in FIG. 6 and indicated with E and shows linkage of the blades with the belt.

FIG. 8 is the scheme of rotation of guide vanes for reverse of ventilation system.

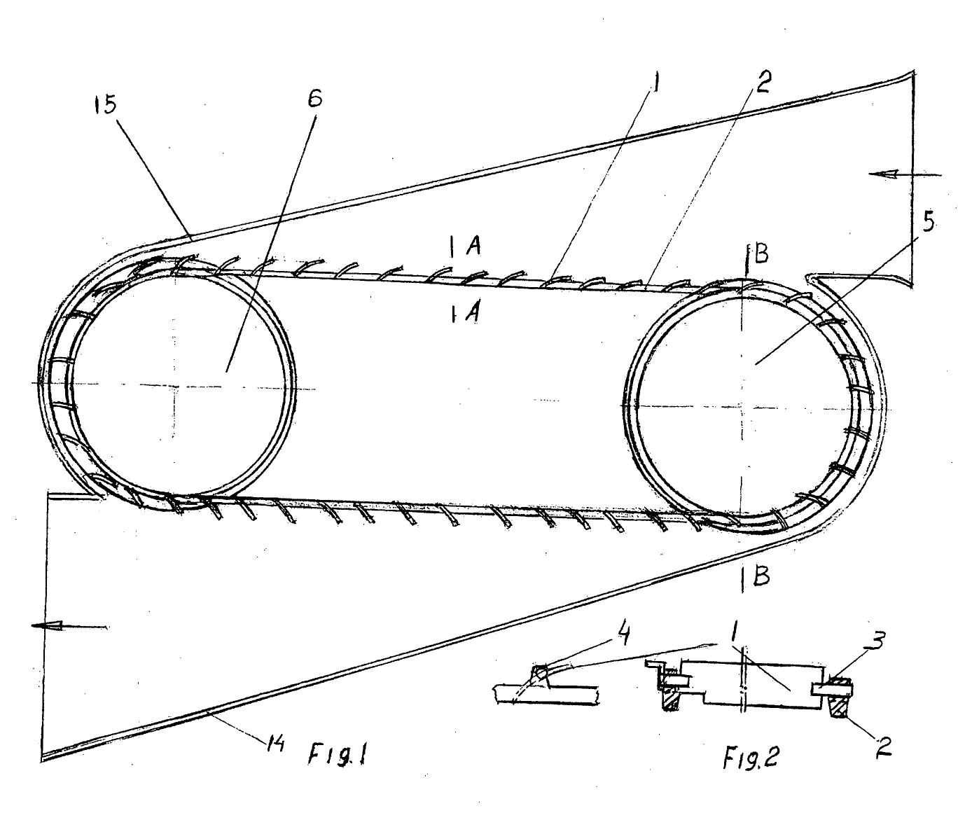

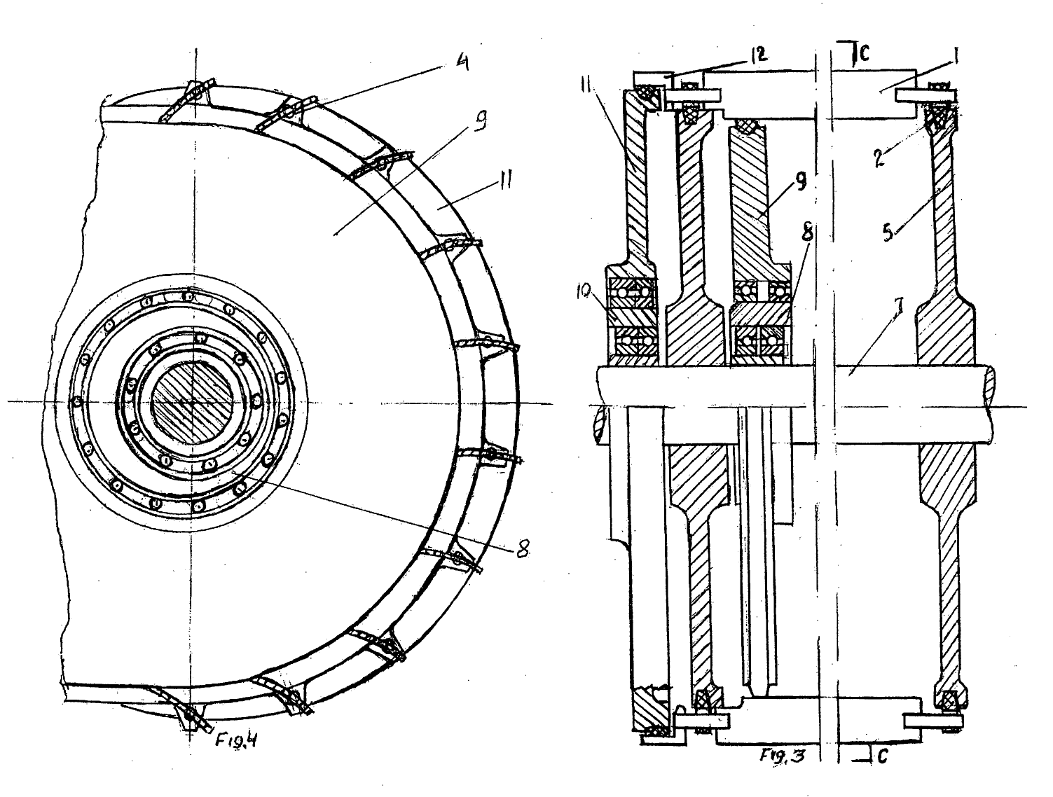

### DETAILED DESCRIPTION OF THE INVENTION

The presented invention will be described by way of example with reference to accompanying drawings listed above.

In one embodiment, the fan, according to the invention, is comprised of blades 1 fixed on two flexible transmissions 2 (belts or chains, for example). To facilitate swivel fixation of the blades 1 on the belts 2, the blades 1 have the shanks 3 that are placed in holes of reefs 4 of belts 2.

The belts 2 encircle leading 5 and follower 6 pulleys. The shaft 7 of the leading pulley 5 is joined with a motor (not shown in the figure).

On the shaft 7 there are also directive disc 9 with eccentric socket 8 and directive disc 11 with eccentric socket 10. Arms 12 installed on the shanks 3 are adjacent to the disc 11.

The air gets in and out through inlet 13 and outlet 14 of frame 15.

The main specific functional characteristic of the system is in the fact that the blades act on interfluent air mainly when the blades move rectilinearly progressively with the belts.

When blades move with backward branch of transmission, position of the blades with respect to the belt gets changed to coincide with the direction of incoming flow.

This veer of the blades is accomplished by engaging the swivel fixation of the blades on the belt. When the blades pass leading pulley 5, directive disc 11 presses on arms 12 due to eccentricity of the disc's position, and the blades begin to veer. The further veer continues as the directive disc 9 presses on edges of the blades. A similar action occurs when blades pass follower pulley 6 and its corresponding set of eccentric discs.

In general, the fan can be set vertically. Advantage of this fan over traditional designs is in its ability to yield large volume with a relatively compact installation.

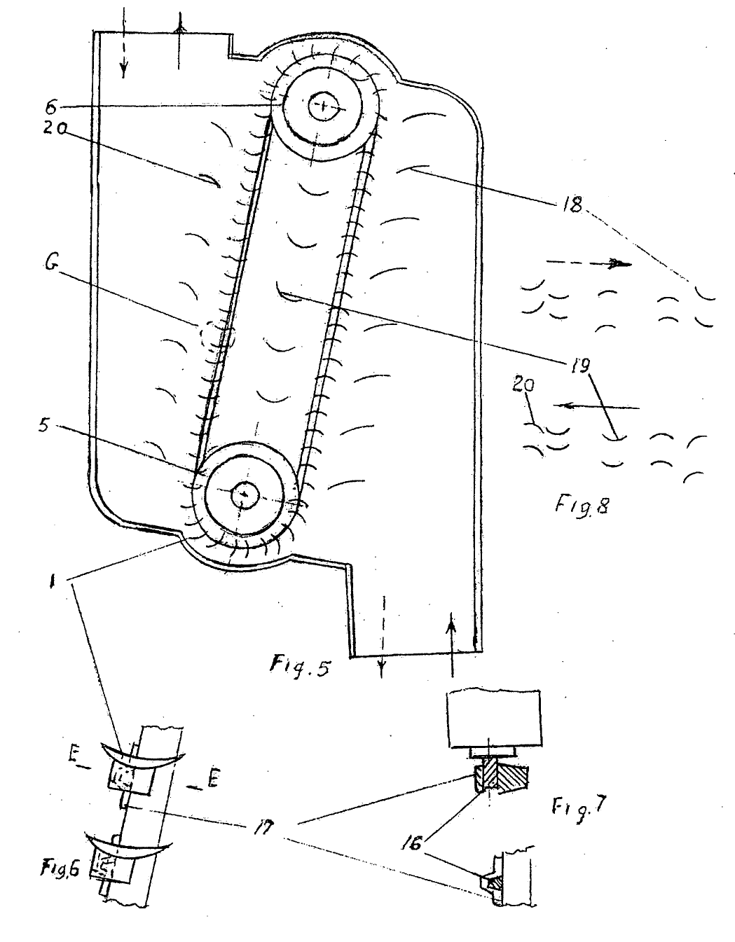

In another embodiment, the linear fan features an alternative design with collocation of the blades that is permanent relative to direction of motion of the belts, will be described hereafter with references to FIGS. 5, 6, 7 and 8.

The shanks 16 of the blades 1 have prismatic form and are attached to the belts with flat straps 17. This kind of fan differs from one described above in that that it does not have directive disks 9 and 11, sockets 8 and 10 and arms 12 and fixation of the blades on the flexible transmission is not of a swivel type.

Cross sections of the blades are symmetrical with respect to direction of movement of the blades. In aerodynamic terms, they form an active cascade of profiles. Required direction of air flow entering onto blades is achieved with inlet guide vanes 18 and 19. The fan also has a set of outlet vanes 20. The placement and spatial position of the blades and vanes relative to each other are shown in FIGS. 5, 6 and 7.

This interaction of blades and vanes provides an additional advantage of enabling reversal of airflow in ventilation system without ever changing direction of motor rotation. FIG. 8 shows how direction of airflow marked with solid arrow in the figure can be changed to the opposite one (marked with dotted arrow in the figure) by turning vanes 18 and 19. This functional feature of the system is important for mining systems of ventilation.

We claim:

1. The linear fan comprising blades fixed on two flexible transmissions, engaging leading and follower pulleys.

2. The linear fan according to claim 1 wherein said blades have cylindrical shanks that are placed in holes of transmission constituting swivel fixation of the said blades on the said transmission. The said fan also features directive disks that are placed on its shaft eccentrically and provide the veer of the said blades.

3. The linear fan according to claim 1 wherein said shanks have prismatic form and attached to the said transmission with flat straps. Outlines of cross sections of said blades are symmetrical with respect to a plane formed by axes of the said pulleys. The said fan comprises guide vanes placed to interact with incoming and outgoing flow of the air.

4. The linear fan according to claims 1 and 3 wherein the guide vanes are fixed in one of two positions: first position for direct operation of the fan, and the second one for reverse operation of the fan.
